(19) United States
(12) Patent Application Publication
(10) Pub. No.: US 2004/0049927 A1
(43) Pub. Date: Mar. 18, 2004

(54) Circular saw with laser alignment

(75) Inventor: Shuming Wu, Nanjing City (CN)

Correspondence Address: LACKENBACH SIEGEL, ONE CHASE ROAD, SCARSDALE, NY, 10583, US

(73) Assignee: Chervon International Trading Co., Ltd., Nanjing (CN)

(21) Appl. No.: 10/323,199

(22) Filed: Dec. 18, 2002

(30) Foreign Application Priority Data
May 14, 2002 (CN) CN 02220541.1

(51) Int. Cl. B27B 9/00

(52) U.S. Cl. 30/391; 30/389; 30/123

(57) ABSTRACT

A circular saw for more precise movement during cutting with a laser alignment system for projecting a maker onto a workpiece to align with a target line to be cut. The laser alignment system comprises a housing, a laser generator, an internal battery which can be replaced without the aid of a tool, a switch which can be independently positioned within the housing and be turned on or off independently or a switch which can be positioned near the main switch of the circular saw and be actuated together with the main switch. The laser line projected by the laser alignment aligns with the plane of a saw blade of the circular saw. Thus, the saw blade can follow the target line by aligning the laser line with the target line.

### FIELD OF INVENTION

The present application relates to a power saw, and more particularly, to a circular saw with laser alignment system for projecting an optical alignment marker onto a workpiece.

### BACKGROUND OF THE INVENTION

The prior electric saw, particularly a circular saw, is mainly used to cut wood drived by a motor to rotate a saw blade. In order to align the saw blade with a target line on a workpiece, the operator must bring the blade into contact with the workpiece to determine if the saw blade is properly aligned with the target line. As is familiar to those skilled in the art, such a circular saw has some disadvantages. First, the operator is required to concentrate his observation exactly ahead of the cutting blade as the blade is pushed along the prescribed and prepared target line, it may have to repeat this procedure several times in order to achieve proper alignment for precise cutting, and this will result in waste of time and material. Also, the target line exactly ahead of the cutting blade may be covered by chip dust and influence the alignment of saw blade with the target line.

### SUMMARY OF THE INVENTION

It is a primary object of the present invention to provide an improved power saw, particularly a circular saw with a laser alignment system for projecting an optical alignment marker onto a workpiece for more precise movement of the blade during cutting.

The laser alignment system is preferably provided on the fixed guard of the saw blade and projects a planar beam of light ahead of the saw blade. The planar beam is aligned with the plane of the saw blade and forms a line on the workpiece. The operator needs only to align the line with a target line to attain the precise cutting. Meanwhile, the laser alignment system have a switch independent of the main switch of the power saw to facilitate the operator to turn on or turn off the laser alignment system, if necessary.

Another object of the present invention is to provide an adjustment mechanism for adjusting the laser generator after the laser alignment system being fixed on the power saw to assure the laser beam aligning with the plane of saw blade.

A further object of the present invention is to provide a means for moving the laser alignment system upwardly or downwardly along the fixed guard to vary the location of the fan-shaped laser light to a greater or lesser extent along the target line.

An even further object of the present invention is to provide a laser alignment system with internal battery cells to power the laser generator of the new and improved circular saw.

Still yet another object of the present invention is to provide new and improved circular saw with a laser alignment system which provides an independent switch near the main switch of the circular saw and uses the trigger of main switch as their mutual trigger to control the on-off of the laser alignment system during operation.

To attain this purpose, the present invention, particularly a new and improved circular saw with a laser alignment system for more precise cutting, comprises a body, a handle, a main power switch trigger to control the motor, a circular blade, a motor to rotate the blade round its axis, a rotatable base plate, a fixed guard to shield the blade teeth above the base plate, a movable guard to shield the blade teeth below the base plate, it further comprises a laser alignment system mounted on the fixed guard to project a laser beam in a line onto the workpiece. The laser alignment system preferably comprises a housing, a laser generator, internal battery cells to power the laser generator. The laser alignment system is preferably provided on the fixed guard of the circular saw. The laser generator further comprises a laser diode, some optical elements to convert the point light projected by said diode to a fan-shaped beam along the workpiece ahead of the blade. The switch and its trigger together are on the housing that can be actuated by the operator independent of the actuation of the main switch.

It could be understood that the switch of laser alignment system can be mounted near the main switch of circular saw inside the handle, and together with a mutual trigger. Slightly push down the actuator of the main switch, the laser alignment system will be turned on, the operator can align the laser line with the target line, then continuously push the actuator down, the motor will be powered on to rotate the blade.

In the present invention, the base plate preferably has an alignment notch at its leading edge in alignment with the plane of the blade. Therefore, the laser alignment system mounted on the fixed guard projects a planar beam in a line through this notch onto the workpiece, it shall also be within the blade plane.

In theory, the laser beam projected by the laser generator will align with the plane of the circular blade after the laser alignment system being mounted on the fixed guard if the machining size and assembly precision of its location can be assured, but it is difficult to do so. It is therefore another object to provide means to adjust the position and angle of the laser generator.

### BRIEF DESCRIPTION OF THE DRAWINGS

FIG. 1 is a perspective view of a preferred circular saw with a laser alignment system mounted on the fixed guard;

FIG. 2 is a left view from left of the circular saw shown in FIG. 1;

FIG. 3 is a embodiment of the laser alignment system with its housing being detached;

FIG. 4 is a cross-sectional view along line A-A of FIG. 3;

FIG. 5 is a perspective view of the laser generator in its bracket;

FIG. 6 is a perspective view of the housing of the laser generator;

FIG. 7 is an embodiment of the cover for battery;

FIG. 8 is an embodiment of the mounting base for a movable laser alignment system;

FIG. 9 is an embodiment of the mounting bracket for a movable laser alignment system;

FIG. 10 is a view of the linkage switch trigger.

### DETAILED DESCRIPTION OF THE PREFERRED EMBODIMENT

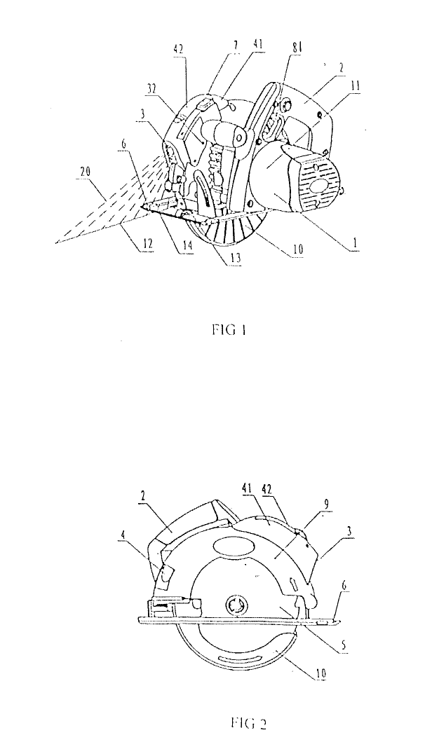

Referring to FIG. 1 to FIG. 3, the preferred embodiment of a new and improved circular saw with a laser alignment system comprises a body 1 with a motor 11 (not shown in the drawing) within it, a handle 2, a circular saw blade 5, a rotatable base plate 6 with a notch 14 in its leading edge 13 to vertically align with the plane of the blade 5, a main switch 8 with trigger 81, a fixed guard 9 for shielding the cutting teeth of the blade 5 above the plate 6, a movable guard 10 for shielding the cutting teeth of the blade 5 below the plate 6, and a laser alignment system 3 provided on the fixed guard 9.

Said laser alignment 3 further comprises a laser generator 17, two internal battery cells 19, and an independent switch 7 for turning the laser generator 17 on or off. Turning on the switch 7, the laser alignment system 3 will project a fan-shaped beam 20 ahead of the saw blade 5 to form a line 12 onto the workpiece. The orientation and assembly accuracy should ensure the projected beam through the notch 14 so as to align with the plane of the blade 5 after the laser alignment system 3 being mounted on the fixed guard 9.

Referring to FIG. 1, there is a notch 14 in the leading edge 13 of said base plate to vertically align with the plane of the blade 5 when the circular saw is set for angle cut. Thus it can be ensured that the laser beam 20 is aligned with the blade plane if the laser alignment system 3 can project a laser beam 20 and form a line 12 through said notch 14 on the workpiece.

Said laser alignment system 3 can be mounted on the fixed guard 9 by screws or other connection means. Referring to FIG. 1 to FIG. 4, said laser alignment system comprises a mounting bracket 15, a laser generator 17, two battery cells 19 for powering said laser generator 17, a housing 41, a battery case 23, and a cover 42 for battery. The laser alignment system 3 can be fixed on the fixed guard 9 by two screws 32 screwed into two screw holes in fixed guard 9 faced the handle through two holes 31 in the side plate 151 of said mounting bracket 15. The orientation and assembly accuracy should ensure that the planar beam 20 projected by the laser generator 17 being aligned with the plane of the blade 5 after the laser alignment system 3 mounted on the fixed guard 9 so that the line 12 is aligned with the blade plane.

But, it is difficult to ensure the laser beam to align with the blade plane in batch production only depending on the design, machining size and assembly accuracy. So, there is another preferred embodiment in this invention to provide an adjustable means for the laser generator 17 to make the laser beam align with the plane of the blade 5 after the laser alignment system 3 being mounted on the fixed guard 9.

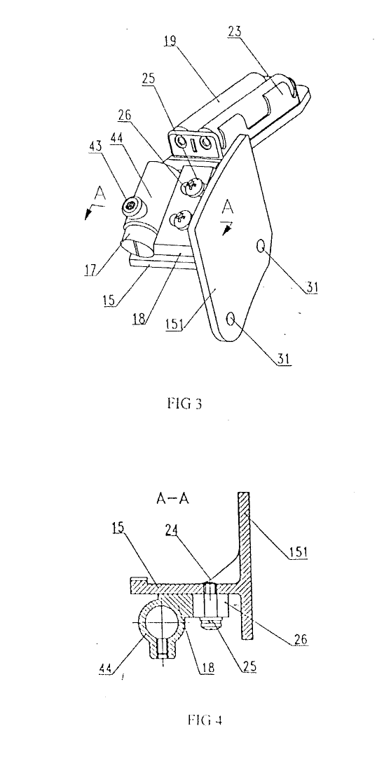

In this preferred embodiment, said housing 41 is fixed on said bracket 15 by one or more screws. Referring to FIG. 3 to FIG. 5, it can be shown that the laser generator 17 has a support block 18 after the housing 41 being removed. The laser generator 17 can rotate in its orientation cylinder 44. Rotate the laser generator 17 to make the planar laser beam 20 vertically to the base plate 6 when the base plate 6 is positioned vertically to the saw blade 5, then screw down a pin screw 43. In addition, there are two slots 26 in the support block 18, the support block is fixed on the bracket 15 by two securing screw 25 screwed into relevant screw holes 24 in the bracket 15. The position of the support block can be adjusted by loosening the screws 25 to make the projected fan-shaped laser beam 20 align with the blade plane. Thus the laser line 12 on the workpiece is also aligned with the plane of the blade 5, this aligned position can be fixed by screws 25.

Referring to FIG. 3, in this preferred embodiment, an internal battery 19 of 3-5 VDC is used for powering the laser generator 17. It will be understood that a transformer connected to the main power of the circular saw can be used to convert the AC power to preferably 3 to 5 DC volts.

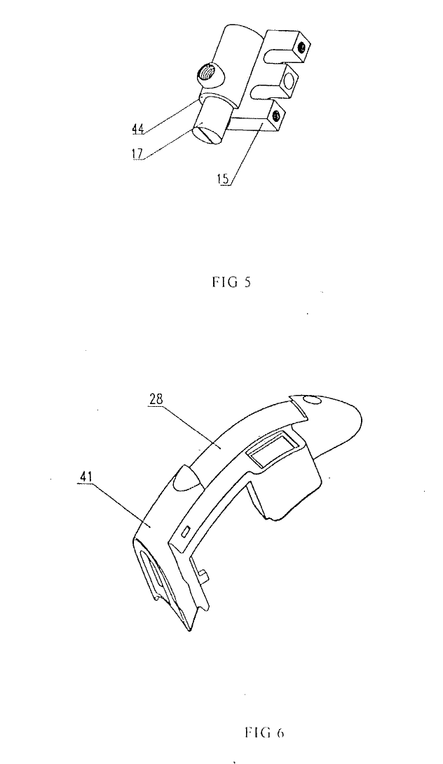

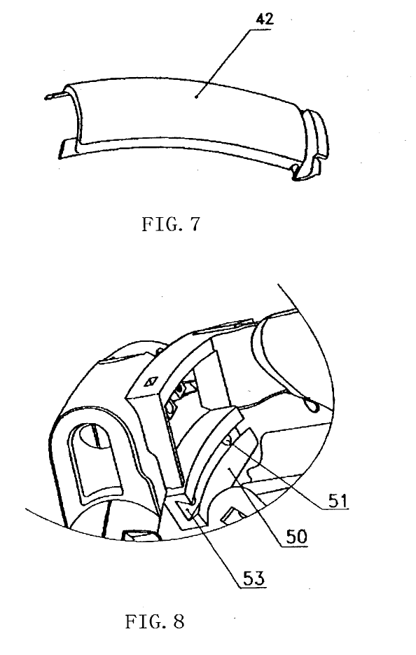

Referring to FIG. 6, there is an open window 28 with a cover 42 in said housing 41 to facilitate the replacement of the battery cells 19 without the aid of any tools. The operator can replace the cells by removing the cover 42.

The switch 7 and its trigger can be provided on the laser alignment system 3 as shown in FIG. 1. The “on” and “off” of the laser generator 17 is independent of the main switch 8. The operator can turn on or turn off the laser alignment system 3 regardless of on and off of the main switch 8.

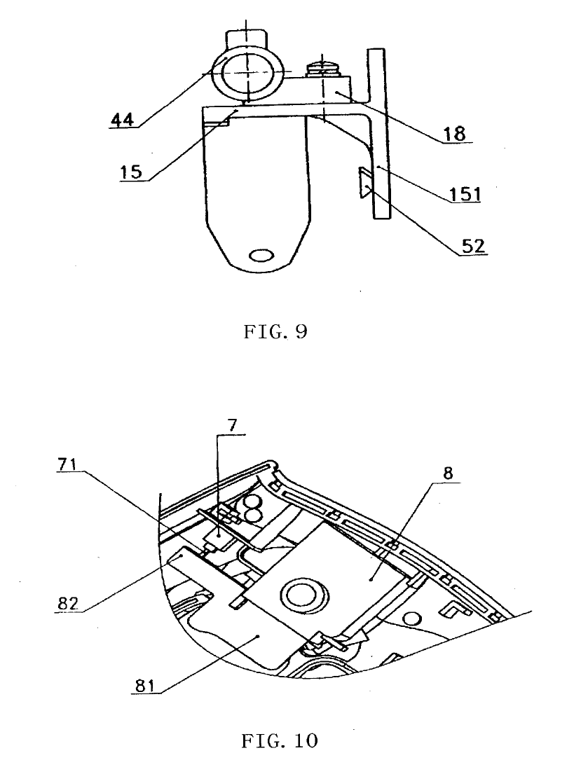

In another embodiment, the position of the laser alignment system 3 can be adjusted. Referring to FIG. 8 and FIG. 9, a mounting block 50 with a arc wedge-shaped groove 53 is mounted on a inside plane 91 of the fixed guard 9 with two screws 51, this inside plane 91 is the plane faced the handle 2. Also, there is a arc wedge-shaped bulge 52 protruded from the inside plane 152 of the side plate 151 to correspond to the groove 53. The curvature of the groove 53 and the bulge 52 is similar to the circumference of the fixed guard 9. Thus it is possible to move the laser alignment system 3 upwardly or downwardly along the fixed guard 9 in order to vary the length of the line 12 formed on the processed product by the fan-shaped laser light 20.

In yet another embodiment as shown in FIG. 10, the switch 7 can be mounted near the main switch 8 inside the handle 2. It has a common actuating lever 82 with the main switch 8. The lever 82 protrudes from a main switch trigger 81 and slightly presses on a trigger 71 of the switch 7. Push down the lever 82 slightly for a distance, as a result, the switch 7 is actuated and the laser generator 17 projects a laser beam 20, then push down the lever 82 continuously, the switch 8 shall be actuated and the blade 5 shall rotate around its shaft.

With the laser line projected by the laser alignment system, the operator does not have to observe the exact front cut of the saw blade as it follows the target line, but rather the operator needs only to visually align the beam with the guide line to ensure the saw blade to follow the guide line. Meanwhile, the alignment is not influenced by the pileup of the chips.

It will be understood by those skilled in the art that the present inventions are not limited to the examples discussed above, but may be changed or modified without departing from the spirit or scope of the invention. Also, it will be understood by those skilled in the art that the laser alignment system is not limited to use the battery cells as the power, and the attachment means may have different configurations. Further, it will be recognized that the laser alignment system of the present invention may be mounted on any suitable surface on a circular saw.

Furthermore, the laser alignment system of the present invention is intended to be compatible with any power saw with saw blade, including table saws, miter saws, cutoff saw, tile cutters, and so on, with a wide variety configurations.

We claim:

1. A circular saw, comprising:
a body (1);
a circular saw blade (5);
a handle (2) with a main switch trigger (8);
a rotatable base plate (6) with a lower planar surface;
a fixed guard (9) for shielding sawteeth of said blade (5) above said plate (6);
and a movable guard (10) for shielding the sawteeth of said blade (5) below said plate (6);
wherein the circular saw further comprising a laser alignment system (3) provided on said fixed guard (9) to project a laser beam (20) in alignment with the plane of said saw blade (5) onto the workpiece to be cut.

2. The circular saw of claim 1, wherein said laser alignment system (3)comprises a bracket (15), a housing (41), a laser generator (17), a switch (7) for controlling said laser generator (17), and internal battery cells (19) for powering said laser generator (17), a side plate (151) of said bracket (15) is fixed on said fixed guard (9), and there is a window (28) on said housing (41) which is fixed on said bracket (15), a cover board (42) can be mounted on or detached from said housing (41) without the aid of any tool in order to facilitate the exchange of the battery cells (19).

3. The circular saw of claim 2, wherein said laser generator (17) is positioned in a orientation cylinder (44) of a support block (18) by a pin screw (43), said laser generator (17) can be rotated within said cylinder (44) after said pin screw (43) being loosed.

4. The circular saw of claim 3, wherein there are two one-end-opened elongated slots (26) in said support block (18), and said block (18) is mounted on said mounting bracket (15) by two securing screws (26) through said elongated slots (26), the position of said block (18) can be adjusted right and left in relation to blade plane so as to make said planar beam (20) align with the blade plane.

5. The circular saw of claim 1 to 4, wherein said switch (7) for controlling said laser generator (17) is positioned on said housing (41) of said laser generator (17), it can be turned on or off independently of said main switch (8).

6. The circular saw of claim 1 to 4, wherein said switch (7) for controlling said laser generator (17) is positioned within said handle (2) of circular saw near said main switch (8), it shares a mutual actuating trigger (81) with said main switch (8).
